(19) United States
(12) Patent Application Publication
(10) Pub. No.: US 2013/0215131 A1
(43) Pub. Date: Aug. 22, 2013

(54) IMAGE GENERATING APPARATUS AND CONTROL METHOD THEREFOR

(71) Applicant: CANON KABUSHIKI KAISHA, (US)

(72) Inventor: Masanori Sato, Yokohama-shi (JP)

(73) Assignee: CANON KABUSHIKI KAISHA, Tokyo (JP)

(21) Appl. No.: 13/759,512

(22) Filed: Feb. 5, 2013

(30) Foreign Application Priority Data
Feb. 16, 2012 (JP) 2012-031670

(51) Int. Cl. G06T 1/60

(52) U.S. Cl. CPC G06T 1/60
USPC 345/557

(57) ABSTRACT

An image generating apparatus comprises an image data storage unit configured to store an original image data therein, and an image data buffering unit that allows data to be read out therefrom at a higher speed than the image data storage unit. A display times counting unit divides a whole of the original image data into a plurality of blocks and counts the number of times each of the blocks has been referenced or utilized for the generation of the image data to be displayed, as the number of display times. A priority order setting unit sets a priority order on a block-by-block basis based on the number of display times thus counted. A buffering control unit performs a control such that image data in a block which is given a higher priority order is stored in the image data buffering unit more preferentially.

### BACKGROUND OF THE INVENTION

1. Field of the Invention

The present invention relates to a technique for speeding-up changing of a display region in an image viewer.

2. Description of the Related Art

In the pathological field, there is a virtual slide system as a substitute for an optical microscope serving as a tool for pathological diagnoses, the virtual slide system being configured to image a test sample placed on a prepared slide and digitize the image of the test sample, thereby making a pathological diagnosis possible on a display. Digitization of a pathological diagnosis by the virtual slide system enables the image of a test sample taken by the conventional optical microscope to be handled as digital data. This can be expected to improve convenience in terms of explanation using a digital image to a patient, sharing of a rare case, speeding-up of telediagnoses, promoting the efficiency of education and practice, and the like.

An image viewer for visualizing image data thus digitized by the virtual slide system serves as an interface directly interlinking the system and a pathologist using the system. For this reason, the usability of the image viewer exerts a great effect on the operability of the system itself.

A conventional image viewer, however, is sometimes inferior in operability to the microscope. The size of pathological image data is generally big to the extent several times, occasionally several hundred times as large as the size of a region displayed on a screen. In displaying such big image data by the image viewer and then updating the displayed data by input of an instruction such as to scroll, the response of screen display to the input is sometimes delayed. Such a delayed response frequently causes a stress on the user of the image viewer. In some cases, the delayed response forms a factor behind hindrance to the widespread use of the virtual slide system. Therefore, an improvement in the display responsiveness of the image viewer leads to removal of one obstacle to the use of the virtual slide system by a pathologist and hence is very important.

The challenge of improving the display responsiveness of the image viewer is not limited to the virtual slide system but is a widely and generally recognized challenge. In order to solve this challenge, it has been a conventional practice to carry out a process including: previously storing image data having a size larger than the screen display region into a buffer memory of a relatively high access speed; and loading display data to be subsequently displayed from the buffer memory when screen updating by scrolling or the like occurs. Hereinafter, the process of previously loading image data or a part thereof into a buffer region of a high access speed in order to improve the screen display responsiveness will be referred to as “buffering”. Such a process is otherwise called “caching” and the memory used for caching is sometimes called a “cache memory” or “cache”. In the present description, the “buffer” and the “cache” are used to have the same meaning.

Buffering is a conventionally and widely known processing method. A typical buffering process frequently includes loading image data corresponding to a region larger than the screen display region evenly in the vertical and horizontal directions. In this case, central portion of the image data region loaded into the buffer memory is actually displayed on the screen. Such a method is effective when it is impossible to predict the direction in which the screen is to be scrolled. In cases where the screen is scrolled in only one direction, however, a large amount of data results which has not been used for screen display. For this reason, there is room for improvement from the viewpoint of space efficiency of the buffer memory. In cases where the amount of one-time scrolling is large, the region of image data to be subsequently displayed is moved to the outside of the region buffered. As a result, image data has to be loaded from a storage device of a lower speed than the buffer memory, thus causing the responsiveness of the image viewer to lower. To avoid such a phenomenon, a larger buffer capacity is simply secured. However, it does not mean that the space efficiency of the buffer memory is raised and, as a result, the major part of the buffered data remains useless. That is, the improvement in the display responsiveness of the image viewer and the used amount of the buffer memory are in an incompatible relation to each other.

The original cause of these problems resides in that the direction in which the subsequent scrolling will occur cannot be predicted. Stated otherwise, if the direction in which the subsequent scrolling will occur can be predicted with a high probability, the space efficiency of buffered data can be improved.

As an instance of such an approach, Japanese Patent Application Laid-open No. 2006-113801 for example describes a process in which data to be subjected to buffering is selected after analysis of the details of the image by utilizing the characteristic that when text data is included in the image data, the text is read in a specific direction. By this approach, the technique described in Japanese Patent Application Laid-open No. 2006-113801 makes the speeding-up of scroll display compatible with efficient use of memory.

Since the direction in which text is read is fixed, buffering utilizing this characteristic is effective. However, the directionality of an image not including data imparted with meaning like text (e.g., a pathological image) is not uniquely determined from the characteristic of the image and, therefore, a problem exists that there is no buffering control method which makes the speeding-up and the efficient use of memory compatible with each other.

### SUMMARY OF THE INVENTION

The present invention has been made with the foregoing problems in view. An object of the present invention is to provide a technique for improving the display responsiveness as well as the space efficiency of the buffer memory.

The present invention in its first aspect provides an image generating apparatus which generates image data to be displayed from original image data for a viewer having a function of displaying an image corresponding to a part of the original image data and changing the part to be displayed in accordance with an operation by a user, the image generating apparatus including: an image data storage unit configured to store the original image data therein; an image data buffering unit that is capable of temporarily storing a part of the original image data therein and allows data to be read out therefrom at a higher speed than the image data storage unit; an image data output unit configured to generate the image data to be displayed from the original image data and use data stored in the image data buffering unit when data needed for generation of the image data to be displayed is stored in the image data buffering unit; a display times counting unit configured to divide a whole of the original image data into a plurality of blocks and count the number of times each of the blocks has been referenced or utilized for the generation of the image data to be displayed, as the number of display times; a priority order setting unit configured to set a priority order on a block-by-block basis based on the number of display times thus counted; and a buffering control unit configured to perform a control such that image data in a block which is given a higher priority order is stored in the image data buffering unit more preferentially.

The present invention in its second aspect provides a method of controlling an image generating apparatus, which includes: an image data storage unit configured to store original image data therein; an image data buffering unit that is capable of temporarily storing a part of the original image data therein and allows data to be read out therefrom at a higher speed than the image data storage unit; and an image data output unit that generates image data to be displayed from the original image data for a viewer having a function of displaying an image corresponding to a part of the original image data and changing the part to be displayed in accordance with an operation by a user, and which uses data stored in the image data buffering unit when data needed for generation of the image data to be displayed is stored in the image data buffering unit, the method comprising the steps of: dividing a whole of the original image data into a plurality of blocks and counting the number of times each of the blocks has been referenced or utilized for the generation of the image data to be displayed, as the number of display times; setting a priority order on a block-by-block basis based on the number of display times thus counted; and performing a control such that image data in a block which is given a higher priority order is stored in the image data buffering unit more preferentially.

The present invention in its third aspect provides a non-transitory computer readable medium recording a computer program for causing an image generating apparatus a method of controlling the image generating apparatus, the apparatus comprising: an image data storage unit configured to store original image data therein; an image data buffering unit that is capable of temporarily storing a part of the original image data therein and allows data to be read out therefrom at a higher speed than the image data storage unit; and an image data output unit that generates image data to be displayed from the original image data for a viewer having a function of displaying an image corresponding to a part of the original image data and changing the part to be displayed in accordance with an operation by a user, and which uses data stored in the image data buffering unit when data needed for generation of the image data to be displayed is stored in the image data buffering unit, the method comprising the steps of: dividing a whole of the original image data into a plurality of blocks and counting the number of times each of the blocks has been referenced or utilized for the generation of the image data to be displayed, as the number of display times; setting a priority order on a block-by-block basis based on the number of display times thus counted; and performing a control such that image data in a block which is given a higher priority order is stored in the image data buffering unit more preferentially.

According to the present invention, it is possible to improve the display responsiveness as well as the space efficiency of the buffer memory.

Further features of the present invention will become apparent from the following description of exemplary embodiments with reference to the attached drawings.

### BRIEF DESCRIPTION OF THE DRAWINGS

FIG. 1 is a block diagram illustrating a system configuration of an image processing system according to a first embodiment;

FIG. 2 is a block diagram illustrating a hardware configuration of an image generating apparatus according to the first embodiment;

FIG. 3 is a functional block diagram of the image generating apparatus according to the first embodiment;

FIG. 4 is a view illustrating the relationship between the whole image data and different regions thereof;

FIG. 5 is a flowchart schematically illustrating an image generating process flow according to the first embodiment;

FIG. 6 is a flowchart illustrating an initial setting process flow according to the first embodiment;

FIG. 7 is a flowchart illustrating a buffer contents updating process flow according to the first embodiment;

FIGS. 8A to 8C are each a schematic view illustrating an example of buffering according to the first embodiment;

FIGS. 9A to 9C are each a schematic view illustrating an example of buffering according to a second embodiment;

FIGS. 10A and 10B are each a schematic view illustrating an exemplary priority order according to a third embodiment;

FIGS. 11A and 11B are each a schematic view illustrating an example of buffering according to the third embodiment; and

FIG. 12 is a block diagram illustrating another configuration of the image processing system.

### DESCRIPTION OF THE EMBODIMENTS

The present invention relates to a technique for improving the display responsiveness of an image viewer at the time of movement of a display region, the image viewer having the function of displaying an image corresponding to a part of original image data and changing (scrolling or the like) the displayed part in accordance with an operation by the user. Specifically, the present invention relates to an apparatus for generating image data to be displayed (display image data) from the original image data, wherein the space efficiency of a buffer memory is improved by appropriately controlling data to be subjected to buffering, so that the display responsiveness is improved totally.

More specifically, the present invention handles the original image data as a group of image data blocks and counts the number of times each of the image data blocks has been referenced or utilized for generating the display image data (hereinafter will be referred to as “the number of display times”). A priority order is set on each image data block based on the number of display times and then that image data block which is given a higher priority order is buffered more preferentially. There are priority order setting methods including a method of setting a higher priority order with increasing number of display times, and a method of setting a higher priority order with decreasing number of display times. The present invention may adopt either method or may allow the two methods to be switched therebetween either automatically or by the user. The former method is suited to cases where a specific region of an image is observed intensively with focus placed thereon, while the latter method is suited to cases where the whole image is observed orderly and exhaustively. Therefore, the present invention is advantageously applicable to systems which handle image data that tends to be observed intensively with focus placed thereon and/or image data the whole of which tends to be observed orderly and exhaustively. A typical example of a preferred application of the present invention is a system configured to allow visual check to be made based on an image displayed on the screen like a virtual slide system to be described in the following embodiments. However, the scope of application of the present invention is not limited thereto but can be applied to any system that displays image data of high resolution and image data of big size.

### First Embodiment

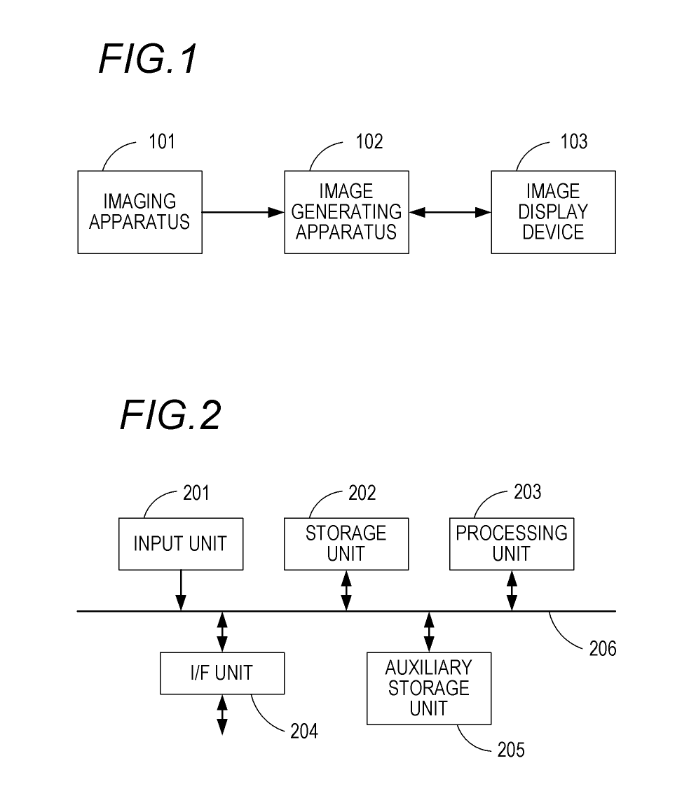

Description will be made of an image processing system according to the first embodiment of the present invention with reference to the drawings. A technique illustrated by the first embodiment is realized based on a system configuration as shown in FIG. 1. Reference numeral 101 denotes an imaging apparatus which corresponds mainly to an imaging section of a virtual slide system. Reference numeral 102 denotes an image generating apparatus which forms a main part for realizing the technique illustrated in the present embodiment and which is configured to receive image data generated by the imaging apparatus 101 and carry out a process for generating display image data. Reference numeral 103 denotes an image display device configured to display on a screen an image based on the display image data received from the image generating apparatus 102. The image generating apparatus 102 also receives information on a screen display region and the like from the image display device 103 and processes such information.

In the present embodiment, the image generating apparatus 102 can be realized by using a computer having a hardware configuration shown in FIG. 2 for example and programs for providing different functions to be described later. Reference numeral 201 denotes an input unit which corresponds to a keyboard, mouse or the like. Reference numeral 202 denotes a storage unit which stores therein programs for realizing the technique illustrated in the present embodiment, processing target data, and the like and which corresponds to RAM or the like. Reference numeral 203 denotes a processing unit which is configured to carry out different calculating processes with respect to the data stored in the storage unit 202 in accordance with the programs stored in the storage unit 202 and which corresponds to a CPU or the like. Reference numeral 204 denotes an I/F unit which is an interface configured to control input/output of data to and from the imaging apparatus 101 and the image display device 103. Reference numeral 205 denotes an auxiliary storage unit (or external storage unit) which corresponds to a hard disk, flash memory or the like. Reference numeral 206 denotes a data bus interconnecting the components 201 to 205.

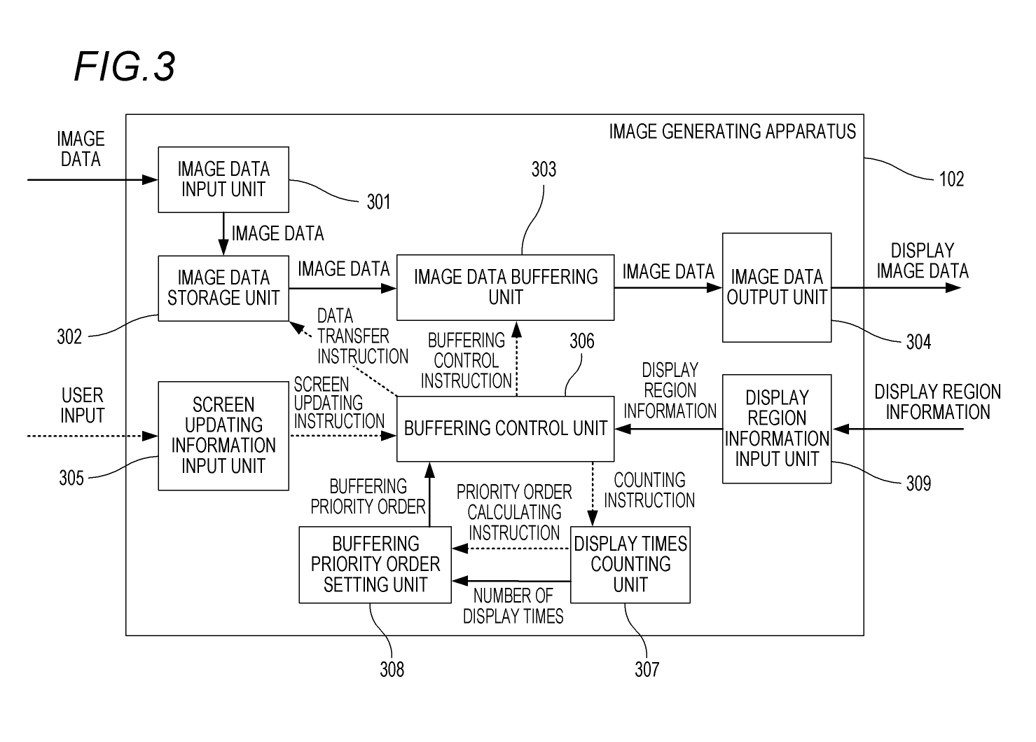

FIG. 3 is a functional block diagram of the image generating apparatus 102 according to the present embodiment. Reference numeral 301 denotes an image data input unit configured to receive input of image data from the imaging apparatus 101. Reference numeral 302 denotes an image data storage unit which is a storage device configured to store therein the image data inputted from the image data input unit 301. Reference numeral 303 denotes an image data buffering unit which is configured to receive a part of the image data from the image data storage unit 302 in response to a buffering control instruction and is capable of temporarily storing the part of the image data therein. The image data buffering unit 303 transmits image data needed to generate display image data to an image data output unit 304. The image data storage unit 302 has to store the whole image data and hence comprises a storage unit having a large capacity (e.g., the auxiliary storage unit 205 shown in FIG. 2). The image data buffering unit 303, on the other hand, is a storage device which functions as a buffer memory for image data and which comprises a device allowing read/write of data to be made at a higher speed than the image data storage unit 302. In the present embodiment, the image data buffering unit 303 is provided in the storage unit 202, but maybe a dedicated buffer memory separate from the storage unit 202. The capacity of the image data buffering unit 303 is smaller than that of the image data storage unit 302 and hence cannot store the whole image data. In the following description, the image data buffering unit 303 will be referred to as a “buffer memory” or simply as a “buffer” as the case may be.

Reference numeral 304 denotes an image data output unit which is configured to generate display image data to be outputted to the image display device 103 from the image data received from the image data storage unit 302 or the image data buffering unit 303. Reference numeral 305 denotes a screen updating information input unit configured to receive user input from an input device such as a mouse for example and transmit a screen updating instruction based on the user input to a buffering control unit 306. The buffering control unit 306 performs the function of controlling data to be stored in the image data buffering unit 303. The buffering control unit 306 transmits a data transfer instruction to the image data storage unit 302 and receives display region information from a display region information input unit 309. The buffering control unit 306 transmits a buffering control instruction based on the information thus received to the image data buffering unit 303. Further, the buffering control unit 306 transmits to a display times counting unit 307 an instruction to count the number of display times of each image data block while receiving a buffering priority order from a buffering priority order setting unit 308.

In response to the counting instruction received from the buffering control unit 306, the display times counting unit 307 counts the number of display times of each image data block and transmits the result thereof to the buffering priority order setting unit 308. The display times counting unit 307 also transmits a buffering priority order calculating instruction to the buffering priority order setting unit 308. The buffering priority order setting unit 308 calculates a buffering priority order based on such information and transmits the result thereof to the buffering control unit 306. The display region information input unit 309 acquires display region information on a current image from the image display device 103 and transmits the result thereof to the buffering control unit 306. With respect to input of image data, a configuration may be adopted such that in response to receipt of the data transfer instruction by the image data input unit 301 from the buffering control unit 306, the image data from the imaging apparatus 101 is transferred directly to the image data buffering unit 303 by bypassing the image data storage unit 302.

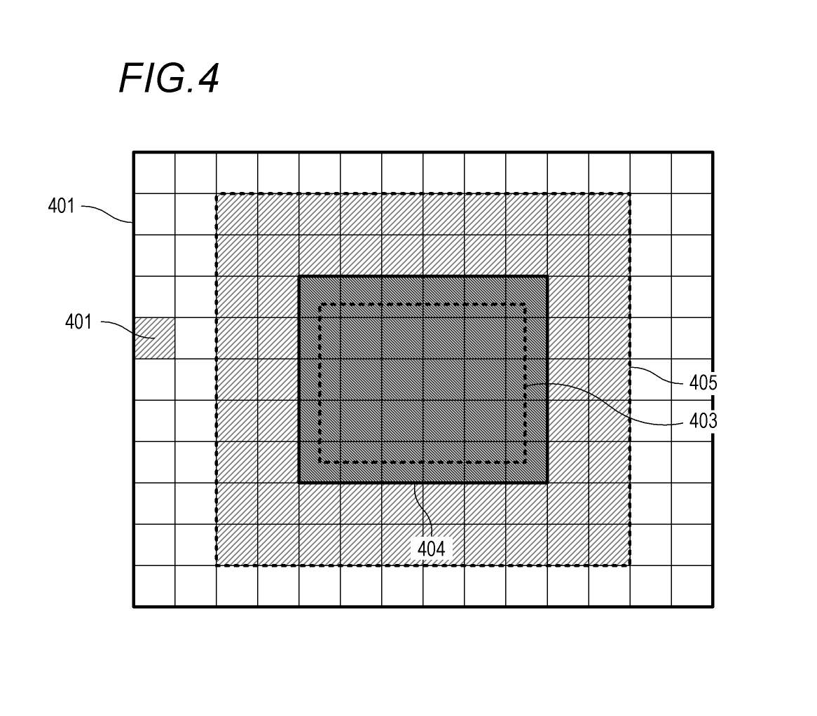

In the present embodiment, an image is handled in units shown in FIG. 4. Reference numeral 401 denotes the whole image data to be handled. The whole image data 401 is divided into a plurality of image data blocks 402. In the present embodiment, processing such as data transfer is performed in units of image data block 402. The image data blocks 402 may be image files which are independent of each other or may be defined as units for internally handling the whole image data 401 forming an independent image file. Reference numeral 403 denotes a region to be actually displayed on the screen by the image display device. Hereinafter, the region 403 will be referred to as a “screen display region”. Reference numeral 404 denotes an image region to be transferred to the image display device 103 for screen display which will hereinafter be referred to as a “transfer data region”. In the present embodiment, the transfer data region 404 is defined as a region which embraces the screen display region 403 completely and consists of a minimum number of image data blocks 402. In some cases, however, the transfer data region 404 may be defined as a larger region than the aforementioned definition. The screen display region 403 and the transfer data region 404 may coincide with each other. Reference numeral 405 denotes a target region to be subjected to buffering which can be previously specified by the user or the associated program and which will hereinafter be referred to as a “buffering target region”. In the present embodiment, the transfer data region 404 is precluded from the buffering target region 405, but may be included in the buffering target region 405 when necessary.

<Image Generating Process>

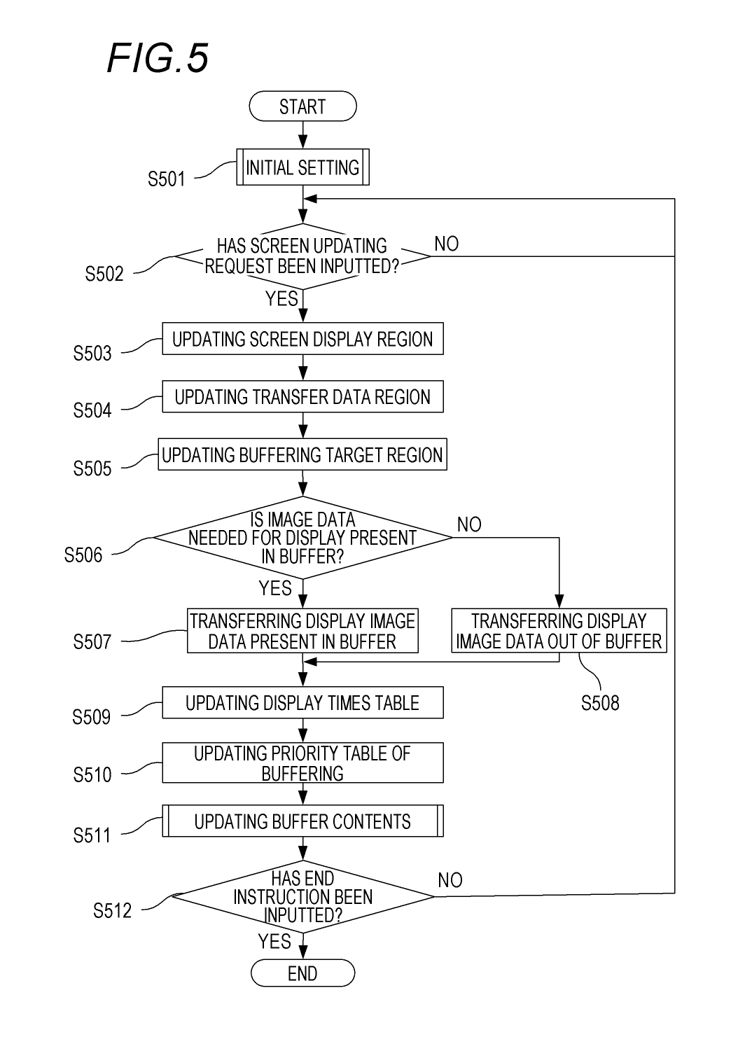

FIG. 5 is a flowchart schematically illustrating an image generating process flow according to the present embodiment. Description will be made of the process flow with reference to FIG. 5.

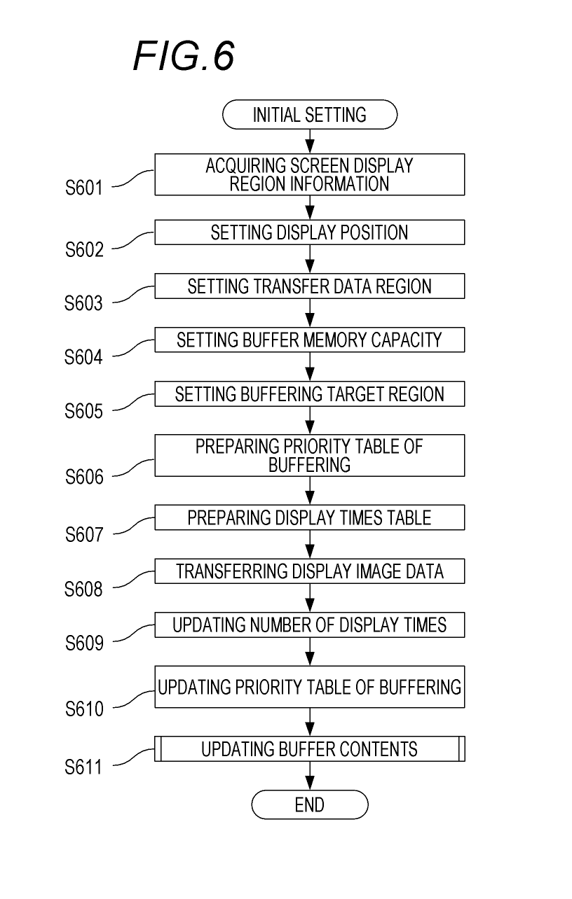

Initially, the buffering control unit 306 performs initial setting (step S501). In step S501, a process illustrated in FIG. 6 is further carried out. A detailed process flow of the initial setting will be described later.

Subsequently to step S501, the buffering control unit 306 determines whether or not a screen updating request in any form has been inputted to the image generating apparatus 102 (condition determining step S502). The screen updating request is an instruction to scroll the screen which is given from the input device such as a mouse for example or a like request. If it is not determined that the screen updating request has been inputted, a standby state continues until receipt of input thereof.

If it is determined in step S502 that the screen updating request has been inputted, the buffering control unit 306 updates screen display region information in accordance with the request inputted (step S503). The “screen display region information” as used herein is meant by information on the position and display area of the screen display region 403 relative to the whole image data 401.

Subsequently, the buffering control unit 306 updates transfer data region information based on the screen display region information thus updated (step S504). The “transfer data region information” as used herein is meant by information on the position and area of the transfer data region 404 relative to the whole image data 401.

Subsequently, the buffering control unit 306 updates buffering target region information (step S505). The “buffering target region information” as used herein is meant to include information on the position and shape of the buffering target region 405 relative to the whole image data 401 and information on the limits of a buffering region. The relative positional relationship between the transfer data region 404 and the buffering target region 405 and the shape of the buffering target region 405 may be changed in step S505 when necessary. For convenience, however, the relationship between the transfer data region 404 and the buffering target region 405 and the shape of the buffering target region 405 are not changed in the present embodiment.

Subsequently, the buffering control unit 306 determines whether or not image data blocks required for screen display are present in the image data buffering unit 303 (condition determining step S506). If the result of the condition determining step S506 is “YES (True)”, the process proceeds to step S507 in which the image data output unit 304 reads out the image data blocks from the image data buffering unit 303, generates display image data and transfers the display image data to the image display device 103. If the result of the condition determining step S506 is “NO (False)”, on the other hand, the process proceeds to step S508 in which the image data output unit 304 reads out image data blocks from the image data storage unit 302, generates display image data and transfers the display image data to the image display device 103. The image data blocks in an intact state may be transferred directly as the display image data or may be subjected to required image processing (e.g., resolution conversion, gradation correction, color correction, image enhancement, image composition, format conversion, and the like) to generate the display image data.

In step S509, the display times counting unit 307 increments (increases the value by one) the number of display times of image data blocks transferred based on a counting instruction by the buffering control unit 306 and updates the contents of a previously prepared display times table with that value. The display times table is a table which is prepared in step S607 included in the initial setting step S501 and which comprises, for example, ID numbers uniquely assigned to all the image data blocks of the whole image data 401 and the cumulative numbers of times of display of the respective data blocks. The step S607 will be described later. In the present embodiment, “the number of display times” is defined as “the number of times of data transfer to the image display device 103”, but may be defined as the number of times of processing needed for image display, for example, decompression of compressed data.

Subsequently, the buffering priority order setting unit 308 determines a buffering priority order with respect to each of the image data blocks present in the buffering target region 405 based on the number of display times set in step S509. Thereafter, the buffering priority order setting unit 308 updates the contents of a previously prepared priority table of buffering with the value of the priority order thus determined (step S510). The priority table of buffering is a table which is prepared in step S606 included in the initial setting step S501 and which comprises, for example, the ID numbers assigned to the image data blocks present in the buffering target region 405 and the buffering priority orders of the respective data blocks. Step S606 will be described later. The buffering priority orders can be determined by any rule that is based on information on the number of display times. For example, the number of display times may be used directly as a buffering priority order. Otherwise, the value obtained by multiplying the number of display times by −1 may be used as a buffering priority order. In the former case, the buffering priority order of an image data block becomes higher as the image data block was displayed more times in the past and, hence, this rule is effective for cases where observation is done by frequently referencing the images displayed in the past. Such cases correspond to detailed diagnoses using a magnification as high as 20 or 40 times for example in displaying an image. In the latter case, the buffering priority order of an image data block becomes higher as the image data block was displayed fewer times in the past and, hence, this rule is effective for cases where observation is done by referencing images that were not displayed in the past. Such cases correspond to screening and the like in which images that were not displayed in the past are displayed sequentially using a magnification as low as 2 or 4 times, or 10 times for example. Thus, plural methods are conceivable for calculating the buffering priority order which are different from each other in preferred application range. Therefore, it is possible to provide plural modes which are different in priority order calculating method from each other and allow the user to perform mode switching (mode selection). Otherwise, a configuration is possible wherein conditions, including a display magnification, diagnostic mode, display mode, and type and size of an image, are previously correlated to preferred priority order calculating methods and the buffering control unit 306 or the buffering priority order setting unit 308 automatically switches between the calculating methods in accordance with the conditions.

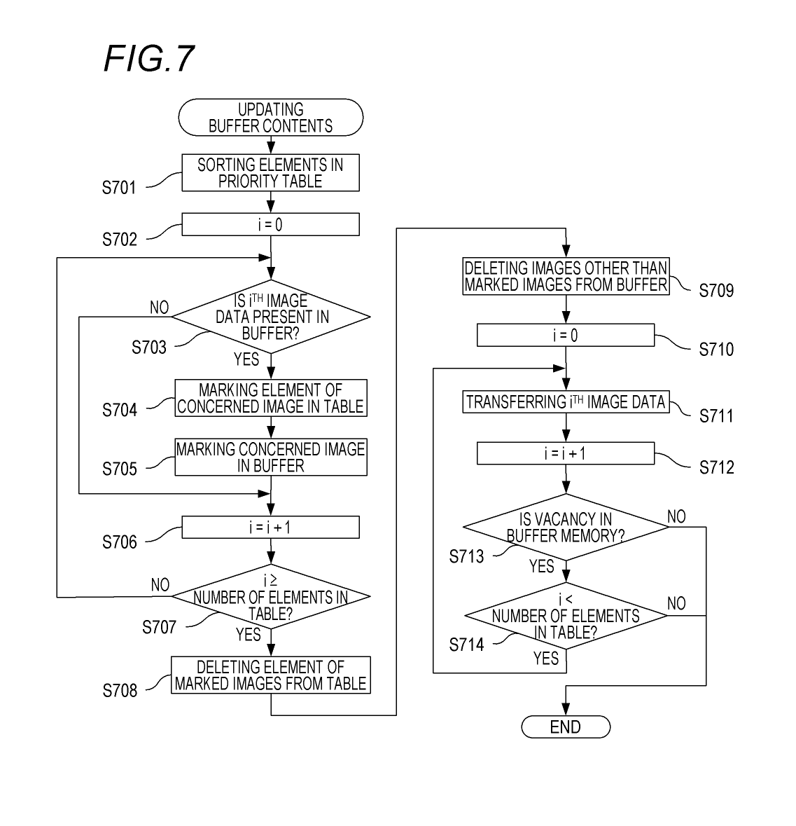

Subsequently, the buffering control unit 306 updates data stored in the image data buffering unit 303 (hereinafter will be referred to as the “buffer contents”) based on the contents of the priority table of buffering updated in step S510 (step S511). The algorithm used in FIG. 5 necessarily updates the buffer contents in response to input of the screen updating request. In cases where the buffer contents need not necessarily be updated, for example, in cases where the scroll amount is too small, step S511 may be eliminated by attaching importance to the processing efficiency when appropriate. Some specific processes are conceivable in step S511. FIG. 7 illustrates one example of such processes. The details of FIG. 7 will be described later.

Subsequently to step S511, the buffering control unit 306 checks whether or not an instruction to end the program has been inputted (condition determining step S512). If the result of the condition determining step S512 is “YES (True)”, the program ends. If result of the condition determining step S512 is “NO (False)”, the process returns to condition determining step S502 and continues.

The schematic description of the image generating process flow according to the present embodiment is completed.

<Initial Setting Step S501>

Description will be made of the detailed process flow of the initial setting step S501 with reference to FIG. 6.

Initially, the buffering control unit 306 acquires the screen display region information from the image display device 103 (step S601). This information is information on the display screen resolution.

Subsequently, the buffering control unit 306 sets the position of the screen display region in the whole image data 401 (step S602). The position and area of the screen display region in the whole image data 401 are determined from the information on the display screen resolution acquired in step S601 and the information on the position set in step S602.

Thereafter, the buffering control unit 306 sets the transfer data region based on the screen display region determined in step S602 (step S603). The position and area of the transfer data region are determined in step S603.

Subsequently, the buffering control unit 306 sets a buffer memory capacity (step S604). The buffer memory capacity is set by the user or the associated program in accordance with the capacity of the storage unit 202 mounted on the image generating apparatus or the like.

Subsequently, the position, area and shape of the buffering target region 405 are set (step S605). The buffering target region 405 has to have a shape such as to embrace the transfer data region 404 completely and has to be larger than the transfer data region 404. So long as these requirements are satisfied, the buffering target region 405 may be set to have any detailed shape. In the present embodiment, the buffering target region 405 is set to have a rectangular shape as shown in FIG. 4.

Subsequently, the buffering control unit 306 prepares the priority table of buffering for storing therein the buffering priority order of each of the image data blocks present in the buffering target region 405 (step S606). As described in relation to step S510, the priority table of buffering comprises the ID numbers of the respective image data blocks and the priority orders of the respective image data blocks. At this time, elements that are equal in number to the image data blocks present in the buffering target region 405 are provided in the table, while the ID numbers of the respective image data blocks are stored in the table. Because the values of the buffering priority orders have not been calculated yet, any desired value, for example zero, is provisionally set as the value of each buffering priority order.

Subsequently, the buffering control unit 306 prepares the display times table for storing the number of display times of each of all the image data blocks in the whole image data 401 (step S607). As described in relation to step S509, the display times table comprises the ID numbers of the respective image data blocks and the cumulative numbers of times of display of the respective image data blocks. At this time, elements that are equal in number to all the image data blocks present in the whole image data 401 are provided in the table, while the ID numbers of the respective image data blocks are stored in the table. Because the image data has not been displayed yet, zero is set as the number of display times of each of all the elements in the table.

Since the processing operations of steps S604 to S607 are not dependent on each other, steps S604 to S607 can be carried out in arbitrary order.

Subsequently, under the control by the buffering control unit 306, the image data output unit 304 reads out the image data blocks in a region corresponding to the transfer data region 404 from the image data storage unit 302 and transfers those image data blocks to the image display device 103 (step S608).

Subsequently, under the control by the buffering control unit 306, the display times counting unit 307 counts the number of display times of each of the image data blocks transferred in step S608 and updates the contents of the display times table prepared in step S607 (step S609). In this state, screen display processing is performed for the first time and, hence, the number of display times of each of the image data blocks transferred is set to one.

Subsequently, the buffering priority order setting unit 308 determines the buffering priority order of each of the image data blocks present in the buffering target region 405 based on the number of display times set in step S609. The contents of the priority table of buffering prepared in step S606 are updated with the value of the buffering priority order thus determined (step S610). Step S610 is the same processing as step S510.

Subsequently, the buffering control unit 306 updates the buffer contents based on the buffering priority order set in step S610 (step S611). Step S611 is the same processing as step S511.

In this way, the initial setting step S501 is completed.

<Buffer Contents Updating Step S511>

One exemplary process flow of the buffer contents updating step S511 will be described below with reference to FIG. 7.

Initially, the buffering control unit 306 sorts all the elements in the priority table of buffering (hereinafter will be simply referred to as the “priority order table”) in descending order of priority (step S701).

Thereafter, the buffering control unit 306 provides an integer variable i and sets the variable i to zero (step S702).

Subsequently, the buffering control unit 306 checks whether or not an image data block corresponding to the i^{th} element in the priority order table is already present in the buffer (condition determining step S703). Specifically, for example a list of the ID numbers corresponding to the image data blocks present in the buffer is prepared in advance and then the ID number corresponding to the i^{th} image data block is simply checked against the list of images in the buffer. If the result of condition determining step S703 is “YES (True)”, the buffering control unit 306 attaches a mark to the i^{th} element in the priority order table (step S704) and attaches a mark to the image data block found out in the buffer (step S705). Such a mark is simply correlated to any desired flag. If the result of condition determining step S703 is “NO (False)”, the process proceeds to step S706.

Subsequently to step S705, the buffering control unit 306 increments the value of the variable i by one (step S706).

Subsequently to step S706, the buffering control unit 306 checks whether or not the value of the variable i is equal to or more than the number of the elements in the priority order table (condition determining step S707). If the result of condition determining step S707 is “NO (False)”, the process returns to condition determining step S703. If the result of condition determining step S707 is “YES (True)”, the buffering control unit 306 deletes the marked element from the priority order table (step S708). As a result, only the elements indicative of those image data blocks of high priority order which are not present in the buffer (i.e., image data blocks to be buffered additionally) remain in the priority order table.

Subsequently to step S708, the buffering control unit 306 deletes the image data blocks other than the marked image from the buffer (step S709). As a result, image data blocks of not so high priority order are deleted, so that vacancies are provided in the buffer.

Subsequently to step S709, the buffering control unit 306 substitutes zero for the variable i (step S710).

Subsequently to step S710, the buffering control unit 306 transfers the image data block which corresponds to the i^{th} element in the priority order table from the image data storage unit 302 to the image data buffering unit 303 (step S711).

Subsequently to step S711, the buffering control unit 306 increments the value of the variable i by one (step S712).

Subsequently to step S712, the buffering control unit 306 checks whether or not there is a vacancy in the buffer (condition determining step S713). If the result of the condition determining step S713 is “YES (True)”, the buffering control unit 306 checks whether or not the value of the variable i is equal to or more than the number of the elements in the priority order table (condition determining step S714). If the result of the condition determining step S714 is “YES (True)”, the process returns to step S711 to continue the buffer contents updating process. If the result of the condition determining step S714 is “NO (False)”, there remains no image data block to be subjected to buffering and, hence, the buffer contents updating process ends. If the result of the condition determining step S713 is “NO (False)”, any more image data cannot be stored in the buffer and, hence, the buffer contents updating process ends.

The detailed description of FIG. 7 is completed. It should be noted that buffer contents updating step S511 may use any process other than the process illustrated in FIG. 7, for example, a process including simply erasing all the contents in the buffer and loading groups of image data blocks of high buffering priority order into the buffer sequentially.

<One Example of Buffering>

Description will be made of how image data blocks are stored in the image data buffering unit 303 during the processes illustrated in FIGS. 5 to 7 by using an example.

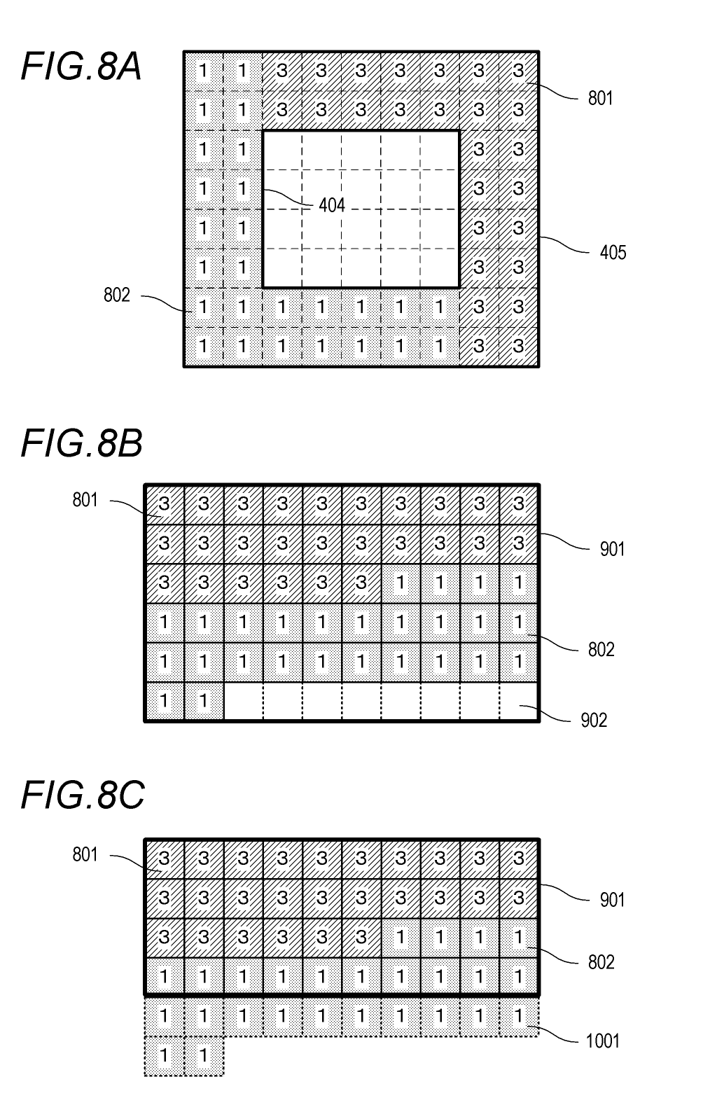

For example, assume that groups of image data blocks given buffering priority orders shown in FIG. 8A are present in the buffering target region 405. Reference numeral 801 denotes a group of image data blocks which are given “3” as the value of a priority order, and reference numeral 802 denotes a group of image data blocks which are given “1” as the value of a priority order. Therefore, the group of image data blocks 801 has a higher priority order than the group of image data blocks 802. FIGS. 8B and 8C each illustrate an example of how to store such groups of image data blocks into the buffer with the priority orders thus set. FIG. 8B is directed to an exemplary case where the buffer capacity is relatively large, and FIG. 8C is directed to an exemplary case where the buffer capacity is relatively small. Reference numeral 901 denotes a buffer region schematically illustrated. In the state shown in FIG. 8B, the capacity of the buffer region 901 is larger than the sum total of the capacities corresponding to all the groups of image data blocks present in the buffering target region 405 and, hence, a vacant region 902 takes place even when all the image data blocks are stored in the buffer. The sequence of storage into the buffer is such that the group of image data blocks 801 of higher priority order is stored first and then the group of image data blocks 802 is stored. In the state shown in FIG. 8C, by contrast, the capacity of the buffer region 901 is smaller than the sum total of the capacities corresponding to all the groups of image data blocks present in the buffering target region 405 and, hence, a group of image data blocks 1001 which cannot be stored in the buffer takes place. Even in such a case, the group of image data blocks 801 of higher priority order is stored first and, hence, image data blocks that are highly likely to be displayed next on the screen are selected and buffered. For this reason, efficient buffering is possible even when the buffer capacity is small.

The image data blocks to be stored in the buffer may be compressed data or uncompressed data, whichever is desired. When focus is placed on the speeding-up of display processing, it is preferable to decompress compressed data and store the data in an uncompressed form during awaiting time for execution of a program or a like time. When focus is placed on reduction in buffer memory capacity, it is preferable to store data as compressed.

The present embodiment makes it possible to perform image data buffering in accordance with the characteristics of diagnostic methods with more efficient use of memory than the conventional technique. As a result, this leads to an improvement in the display responsiveness of the image viewer. Specifically, in cases where detailed observation is made by again referencing images displayed in the past, buffering with more efficient use of memory than the conventional technique becomes possible by giving a higher priority order to image data having been displayed more times. In cases where observation is made by displaying the whole image orderly and exhaustively as in screening, buffering with more efficient use of memory than the conventional technique becomes possible by giving a higher priority order to image data having been displayed fewer times.

### Second Embodiment

The second embodiment of the present invention will be described with reference to the drawings.

Though the second embodiment is similar to the first embodiment in system configuration, hardware configuration, functional blocks and processing algorithm, the second embodiment is different from the first embodiment in the method of calculating the buffering priority order from the number of display times of an image.

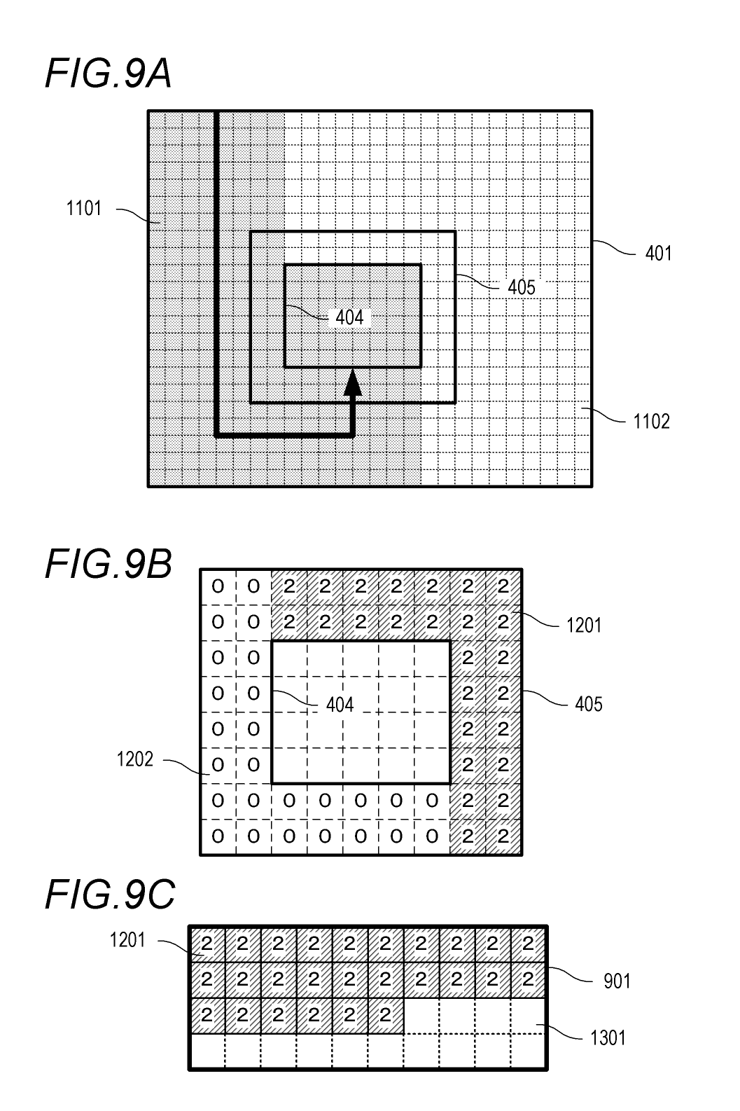

The present embodiment exemplifies a state shown in FIG. 9A. FIG. 9A illustrates the state in which the transfer data region 404 has been moved along the arrow. Specifically, in order to observe the whole image data 401 exhaustively, the display region is moved in one direction (the vertical direction in FIG. 9A) from a corner of the image (the upper left corner in FIG. 9A) and, after completion of display of an image corresponding to one column (or one row), the display region moves to the next column (or row) for a similar operation to be performed. Reference numeral 1101 denotes that region of the whole image data 401 which has been already displayed by the image display device 103. Reference numeral 1102 denotes that region of the whole image data 401 which has not been displayed yet by the image display device 103. Such a screen display method (display region moving method) is frequently practiced by a pathologist in searching for apart suspected to be a pathologically changed part by using an image having a magnification as low as 2, 4 or 10 times (called “screening”).

In the present embodiment, the value of “0” which is the lowest priority order is set on image data blocks having been already displayed. This means that the image data blocks having been already displayed on the screen are precluded from the buffering targets. On the other hand, any positive integer as a buffering priority order is set on image data that has not been displayed on the screen yet. FIG. 9B illustrates a state caused by this method. Reference numeral 1201 in FIG. 9B denotes image data blocks which have not been displayed yet and which are given the value of “2” as a buffering priority order. Reference numeral 1202 denotes image data blocks which have been already displayed and which are given the value of “0” as a buffering priority order.

FIG. 9C is a schematic view illustrating a buffer region having been subjected to buffering using such priority orders. As already described, since the image data blocks 1202 having the buffering priority order “0” are not subjected to buffering, only the group of image data blocks 1201 having the priority order “2” are subjected to buffering in the buffer region 901. Therefore, unlike the first embodiment, a vacant region 1301 takes place in the buffer even when the capacity of the buffer region 901 is smaller than the sum total of the capacities corresponding to the groups of image data blocks in the buffering target region. That is, the capacity of the buffer region can be reduced further than in the first embodiment by carrying out the process illustrated in the present embodiment.

The buffering control according to the present embodiment makes it possible to realize a buffering process with more efficient use of memory than the conventional technique and the method of the first embodiment by precluding image data blocks having been already displayed from the buffering targets. Further, since a relatively small buffer capacity can serve the purpose, it is possible to improve the hit ratio of a cache system, as well as to realize a faster display action than in the first embodiment by reduction in the number of occurrences of swap-in and swap-out by a virtual storage system. The method according to the present embodiment is effective particularly for cases where the entire image is displayed orderly and exhaustively as in screening used in pathological diagnoses.

### Third Embodiment

The third embodiment of the present invention will be described with reference to the drawings.

Though the third embodiment is similar to the first embodiment in system configuration, hardware configuration, functional blocks and processing algorithm, the third embodiment is different from the first embodiment in the method of calculating the buffering priority order from the number of display times of an image.

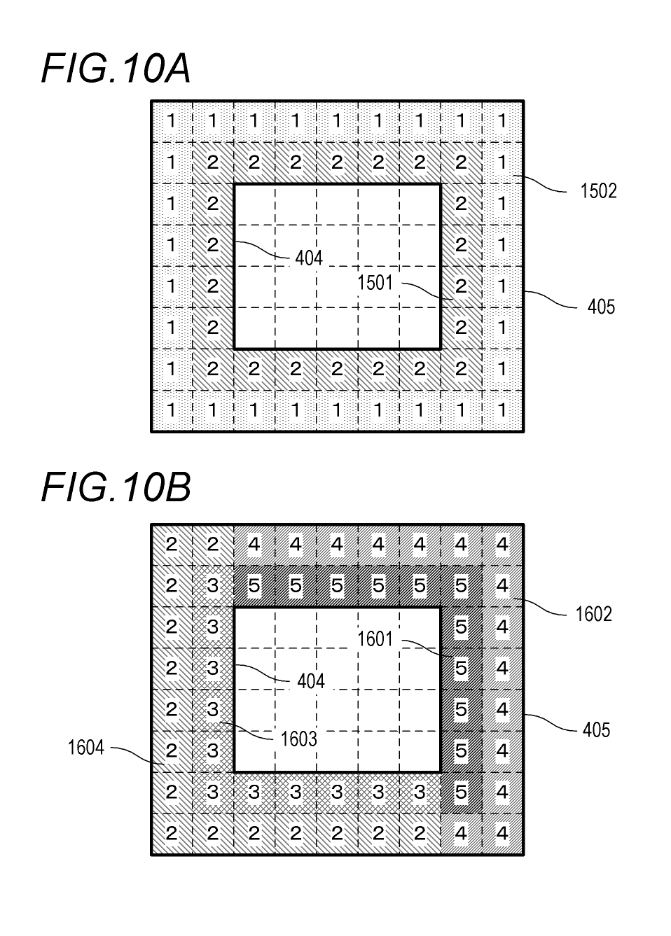

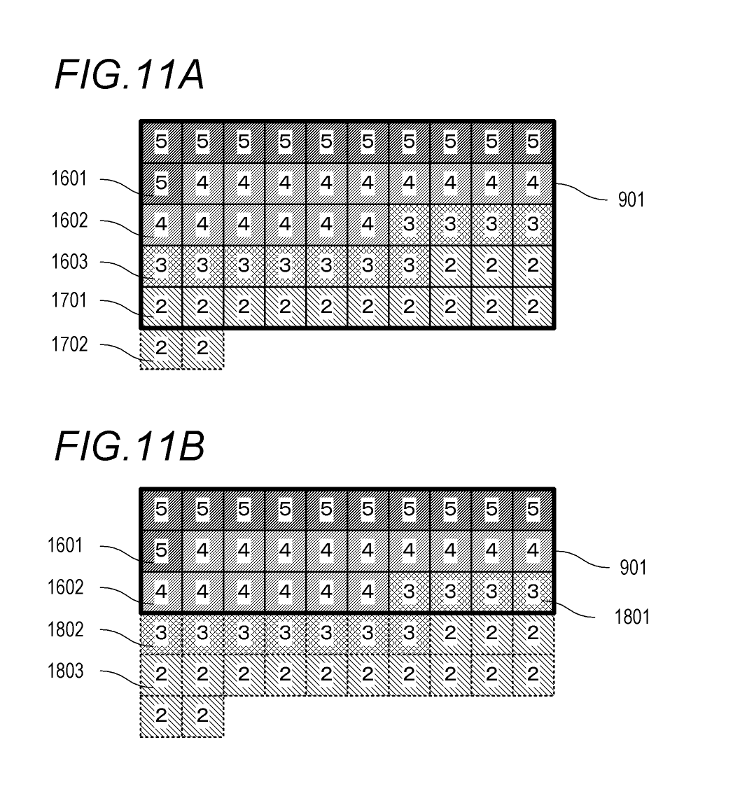

FIGS. 10A, 10B, 11A and 11B illustrate methods of calculating buffering priority orders according to the present embodiment and the results of buffering obtained thereby.

While the first and second embodiments are each configured to calculate buffering priority orders by using only the number of display times of each image data block, the present embodiment is configured to calculate buffering priority orders by using the distance on an image from a region displayed by the image display device to each image data block in addition to the number of display times.

Consideration is given to a method of giving priority orders as illustrated in FIG. 10A for example. In FIG. 10A there are shown a group of image data blocks 1501 having a priority order “2” which are situated adjacent to the transfer data region 404, and a group of image data blocks 1502 having a priority order “1” which are situated outside the group of image data blocks 1501. The group of image data blocks 1501 is given a higher priority order than the group of image data blocks 1502 because the distance from the transfer data region 404 to the group of image data blocks 1501 is closer than that from the transfer data region 404 to the group of image data blocks 1502. Thus, the priority order calculating method according to the present embodiment calculates the distance between each image data block and the transfer data region 404 and gives a higher priority order to a block situated closer to the transfer data region 404. In scrolling an image, it is normal that an image in a region situated close to a current screen display region is highly likely to be displayed. For this reason, the third embodiment can be expected to realize more efficient buffering than the first embodiment by giving priority orders in accordance with distances.

FIG. 10B illustrates exemplary buffering priority orders given by taking both the number of display times and the distance from the transfer data region into consideration. The value of each priority order shown in FIG. 10B is the sum total of the value of each priority order based on the distance shown in FIG. 10A and the value of each priority order based on the number of display times shown in FIG. 8A. Reference numeral 1601 denotes image data blocks given a priority order “5”, reference numeral 1602 denotes image data blocks given a priority order “4”, reference numeral 1603 denotes image data blocks given a priority order “3”, and reference numeral 1604 denotes image data blocks given a priority order “2”.

FIGS. 11A and 11B each illustrate an exemplary result of buffering performed in accordance with the values of priority orders shown in FIG. 10B. FIG. 11A illustrates the exemplary result obtained when the buffer capacity is relatively large and FIG. 11B illustrates the exemplary result obtained when the buffer capacity is relatively small. In the case of FIG. 11A, the image data blocks 1601 to 1603 which are given priority orders equal to or more than “3” are all stored in the buffer. Data 1701 forming a part of the image data blocks 1604 given a priority order “2” is also stored in the buffer. Reference numeral 1702 denotes image data blocks which fail to be stored in the buffer. In the case of FIG. 11B, the image data blocks 1601 and 1602 which are given priority orders equal to or more than “4” are all stored in the buffer. Data 1801 forming a part of the image data blocks 1603 given a priority order “3” is also stored in the buffer. Other data blocks 1802 and 1803 fail to be stored in the buffer. In either case, image data blocks are subjected to buffering in descending order of buffering priority and, hence, efficient buffering in accordance with the buffer capacity can be realized.

The present embodiment makes it possible to perform image data buffering in accordance with the characteristics of diagnostic methods with more efficient use of memory than the conventional technique and the first embodiment. As a result, this leads to an improvement in the display responsiveness of the image viewer. Particularly the priority order calculating method which takes the distance from the transfer data region in addition to the priority order based on the number of display times into consideration can realize a buffering process with more efficient use of memory than in the first embodiment.

While the present embodiment uses the method including simply adding up the priority order based on the number of display times and the priority order based on the distance, the priority order calculating method based on both the number of display times and the distance is not limited thereto. For example, the two priority orders may be weighted and added up. The priority orders may be determined using a predetermined function or table. That is, the priority orders may be calculated in any manner so long as the indicator used is indicative of both the characteristic that the priority order becomes higher with increasing (or decreasing) number of display times and the characteristic that the priority order becomes higher with decreasing distance from the transfer data region. The priority orders maybe calculated by further taking another parameter into consideration in addition to the number of display times and the distance. Further, as described in relation to the first embodiment, it is possible to adopt a configuration wherein the priority order calculating methods can be automatically switched therebetween in accordance with display magnifications, diagnosis modes, display modes, and types and sizes of images or a configuration wherein the user is allowed to switch to his or her preferred calculating method.

<Other System Configurations>

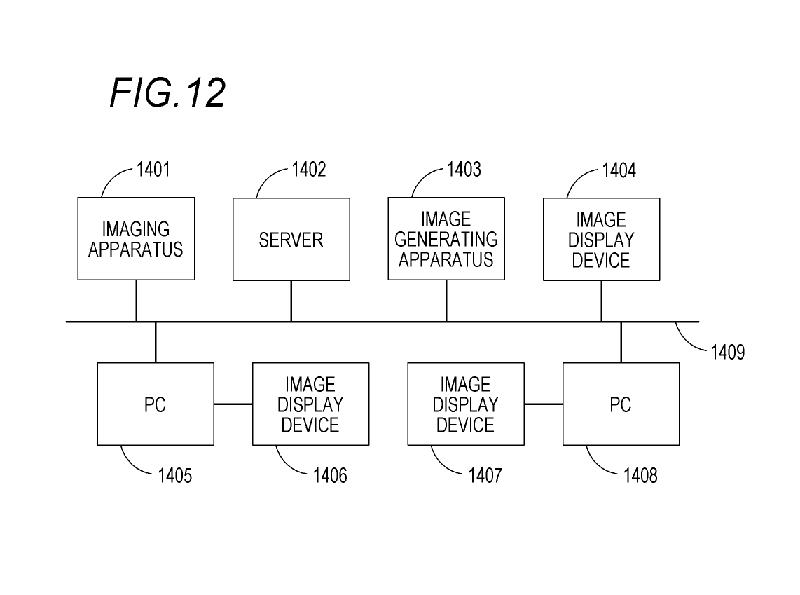

While the foregoing first to third embodiments are each directed to the image processing system comprising the imaging apparatus, image generating apparatus and image display device as illustrated in FIG. 1, there is no limitation to this system configuration. For example, a system configuration as shown in FIG. 12 is possible which comprises a plurality of devices connected to each other via a network. Reference numeral 1401 denotes an imaging apparatus which corresponds mainly to the imaging section of a virtual slide system. Reference numeral 1402 denotes a server which is a storage of a large capacity storing therein image data taken and generated by the imaging apparatus 1401 and like data (image server). Reference numeral 1403 denotes an image generating apparatus which forms a main part for realizing the technique of the present embodiment and which loads thereinto image data stored in the server 1402 and processes the image data. Reference numeral 1404 denotes an image display device configured to receive the image data processed by the image generating apparatus 1403 and displays the image data on the screen. Reference numerals 1405 and 1408 each denote a typical personal computer (PC), and reference numerals 1406 and 1407 each denote an image display device connected to the associated one of the PCs. Reference numeral 1409 denotes a network line which allows a variety of data to pass therethrough. Such a system configuration can also improve the display responsiveness of each image display device by performing the buffering control described in each of the first to third embodiments.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., non-transitory computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-31670, filed on Feb. 16, 2012, which is hereby incorporated by reference herein in its entirety.

What is claimed is:

1. An image generating apparatus which generates image data to be displayed from original image data for a viewer having a function of displaying an image corresponding to a part of the original image data and changing the part to be displayed in accordance with an operation by a user, the image generating apparatus comprising:
an image data storage unit configured to store the original image data therein;
an image data buffering unit that is capable of temporarily storing apart of the original image data therein and allows data to be read out therefrom at a higher speed than the image data storage unit;
an image data output unit configured to generate the image data to be displayed from the original image data and use data stored in the image data buffering unit when data needed for generation of the image data to be displayed is stored in the image data buffering unit;
a display times counting unit configured to divide a whole of the original image data into a plurality of blocks and count the number of times each of the blocks has been referenced or utilized for the generation of the image data to be displayed, as the number of display times;
a priority order setting unit configured to set a priority order on a block-by-block basis based on the number of display times thus counted; and
a buffering control unit configured to perform a control such that image data in a block which is given a higher priority order is stored in the image data buffering unit more preferentially.

2. The image generating apparatus according to claim 1, wherein the priority order setting unit sets a higher priority order on a block having been displayed fewer times.

3. The image generating apparatus according to claim 1, wherein the priority order setting unit sets a higher priority order on a block having been displayed more times.

4. The image generating apparatus according to claim 1, wherein the priority order setting unit sets a lowest priority order on a block having been already displayed on a screen.

5. The image generating apparatus according to claim 1,
wherein the priority order setting unit sets a priority order on a block-by-block basis based on the number of display times of a block and a distance on an image from a display region displayed on the viewer to the block, and
the priority order setting unit sets a higher priority on a block which has been displayed fewer times and is situated closer to the display region.

6. The image generating apparatus according to claim 1,
wherein the priority order setting unit sets a priority order on a block-by-block basis based on the number of display times of a block and a distance on an image from a display region displayed on the viewer to the block, and
the priority order setting unit sets a higher priority order on a block which has been displayed more times and is situated closer to the display region.

7. The image generating apparatus according to claim 1, wherein the user is allowed to select a priority order calculating method to be carried out by the priority order setting unit, from a plurality of methods including a method of setting a higher priority order on a block having been displayed fewer times and a method of setting a higher priority order on a block having been displayed more times.

8. A method of controlling an image generating apparatus, which includes:
an image data storage unit configured to store original image data therein;
an image data buffering unit that is capable of temporarily storing a part of the original image data therein and allows data to be read out therefrom at a higher speed than the image data storage unit; and
an image data output unit that generates image data to be displayed from the original image data for a viewer having a function of displaying an image corresponding to a part of the original image data and changing the part to be displayed in accordance with an operation by a user, and which uses data stored in the image data buffering unit when data needed for generation of the image data to be displayed is stored in the image data buffering unit,
the method comprising the steps of:
dividing a whole of the original image data into a plurality of blocks and counting the number of times each of the blocks has been referenced or utilized for the generation of the image data to be displayed, as the number of display times;
setting a priority order on a block-by-block basis based on the number of display times thus counted; and
performing a control such that image data in a block which is given a higher priority order is stored in the image data buffering unit more preferentially.

9. A non-transitory computer readable medium recording a computer program for causing an image generating apparatus a method of controlling the image generating apparatus,
the apparatus comprising:
an image data storage unit configured to store original image data therein;
an image data buffering unit that is capable of temporarily storing a part of the original image data therein and allows data to be read out therefrom at a higher speed than the image data storage unit; and
an image data output unit that generates image data to be displayed from the original image data for a viewer having a function of displaying an image corresponding to a part of the original image data and changing the part to be displayed in accordance with an operation by a user, and which uses data stored in the image data buffering unit when data needed for generation of the image data to be displayed is stored in the image data buffering unit,
the method comprising the steps of:
dividing a whole of the original image data into a plurality of blocks and counting the number of times each of the blocks has been referenced or utilized for the generation of the image data to be displayed, as the number of display times;
setting a priority order on a block-by-block basis based on the number of display times thus counted; and
performing a control such that image data in a block which is given a higher priority order is stored in the image data buffering unit more preferentially.
